(19) United States
(12) Patent Application Publication
(10) Pub. No.: US 2012/0311242 A1
(43) Pub. Date: Dec. 6, 2012

(54) DATA PROCESSING SYSTEM

(75) Inventor: Shinichi SUZUKI, Kanagawa (JP)

(73) Assignee: RENESAS ELECTRONICS CORPORATION, Kanagawa (JP)

(21) Appl. No.: 13/486,857

(22) Filed: Jun. 1, 2012

(30) Foreign Application Priority Data
Jun. 3, 2011 (JP) 2011-125235

(51) Int. Cl. G06F 12/02

(52) U.S. Cl. 711/103; 711/E12.008

(57) ABSTRACT

A data processing system is provided, which can realize speeding up and facilitation of data processing using a program and a parameter of a scale larger than the maximum storage capacity of an available on-chip nonvolatile memory. A program and a parameter of a scale larger than the maximum storage capacity of the on-chip nonvolatile memory are stored in a nonvolatile semiconductor memory device coupled to the exterior of a semiconductor data processing device, and responding to the determination result of the information supplied from the exterior, the semiconductor data processing device downloads an internally required program and parameter from the nonvolatile semiconductor memory device, and rewrites the on-chip nonvolatile memory. When the program is rewritten, software reset processing is performed to execute the program from a starting address.

### CROSS-REFERENCE TO RELATED APPLICATIONS

The disclosure of Japanese Patent Application No. 2011-125235 filed on Jun. 3, 2011 including the specification, drawings and abstract is incorporated herein by reference in its entirety.

### BACKGROUND

The present invention relates to a data processing system for rewriting a program and a parameter of an on-chip nonvolatile memory residing in a semiconductor data processing device, such as a microcomputer, and especially relates to technology which is effective when applied to, for example, an AC servo, a general-purpose inverter, an air-conditioner, a power conditioner, a vehicle, or a communication terminal.

Technology for rewriting a program and a parameter of an on-chip nonvolatile memory residing in a semiconductor data processing device such as a microcomputer is disclosed by Patent Literature 1 through Patent Literature 6. These Patent Literatures disclose a PROM writer write mode and an on-board write mode as a rewrite mode to a flash memory as an on-chip electrically rewritable nonvolatile memory of a microcomputer. In the PROM writer write mode, the microcomputer of which the PROM writer write mode is set up is coupled to a PROM writer via a socket adapter, and the direct rewrite control of the on-chip flash memory is performed by the ROM writer. In the on-board write mode, the microcomputer is kept as implemented in the system, a central processing unit downloads a program or a parameter using a communication interface, such as SCI and USB, and the program and parameter which have been downloaded are written in the flash memory by the central processing unit executing a rewrite control program. The on-board write mode is utilized for the initial write of a program and a parameter. The on-board write mode is also utilized for bug patch, version upgrade, etc. of a program. Patent Literature 7 also discloses a technology of the on-board write to an on-chip flash memory residing in a microcomputer.

(Patent Literature 1) Japanese Patent Laid-open No. 2008-004258

(Patent Literature 2) Japanese Patent Laid-open No. 2007-095093

(Patent Literature 3) Japanese Patent Laid-open No. 2002-304894

(Patent Literature 4) Japanese Patent Laid-open No. Hei 11 (1999)-288410

(Patent Literature 5) Japanese Patent Laid-open No. Hei 5(1993)-266219

(Patent Literature 6) Japanese Patent Laid-open No. Hei 5(1993)-266220

(Patent Literature 7) Japanese Patent Laid-open No. 2001-357690

### SUMMARY

The present inventors have studied the following issue: that is, an on-chip rewritable nonvolatile memory residing in a microcomputer stores a program and a parameter and is arranged near a central processing unit, and improvement of the access speed of the central processing unit to the nonvolatile memory is aimed at, thereby attaining enhancement of the execution speed of a program and the reference speed of a parameter.

However, the maximum storage capacity of the on-chip nonvolatile memory available in such a way is limited from the viewpoint of cost of a microcomputer, a chip size, etc.; accordingly, it is necessary to adopt a new measure when a program and a parameter larger than the limit is utilized. It has been clarified further that, when such a rewrite is performed using the PROM writer write mode or the on-board write mode, if new program execution is started after performing the power-on reset, it takes too long to resume the processing, causing inconvenience in some kind of data processing.

The present invention has been made in view of the above circumstances and provides a data processing system which can realize speeding up and facilitation of data processing using a program and a parameter of a scale larger than the maximum storage capacity of an available on-chip nonvolatile memory.

The above and other purposes and new features will become clear from description of the specification and the accompanying drawings of the present invention.

The following explains briefly an outline of typical inventions to be disclosed by the present application.

That is, a program and a parameter of a scale larger than the maximum storage capacity of an available on-chip nonvolatile memory are stored in a nonvolatile semiconductor memory device coupled to the exterior of a semiconductor data processing device, and responding to the determination result of the information supplied from the exterior, the semiconductor data processing device downloads the internally required program and parameter from the nonvolatile semiconductor memory device, and rewrites the on-chip nonvolatile memory therewith. When the program is rewritten, software reset processing is performed to execute the program from a starting address.

The following explains briefly an effect obtained by the typical inventions to be disclosed in the present application.

That is, it is possible to realize speeding up and facilitation of data processing using a program and a parameter of a scale larger than the maximum storage capacity of an available on-chip nonvolatile memory.

### BRIEF DESCRIPTION OF THE DRAWINGS

FIG. 1 is a block diagram illustrating a data processing system according to Embodiment 1 of the present invention;

FIG. 2 is a block diagram illustrating interface signals between an MCCNT and an EMCRD;

FIG. 3 is an explanatory diagram illustrating a logical configuration of a microcomputer, concerning transfer control of a user program;

FIG. 4 is a flow chart illustrating execution operation of a user program using the software of the logical configuration explained in FIG. 3, in the data processing system illustrated in FIG. 1;

FIG. 5 is a block diagram illustrating a data processing system according to Embodiment 2 of the present invention;

FIG. 6 is an explanatory diagram illustrating a logical configuration of a microcomputer illustrated in FIG. 5, concerning transfer control of a user program;

FIG. 7 is a flow chart illustrating execution operation of a user program using the software of the logical configuration explained in FIG. 6, in the data processing system illustrated in FIG. 5;

FIG. 8 is a block diagram illustrating a data processing system according to Embodiment 3 of the present invention;

FIG. 9 is an explanatory diagram illustrating a logical configuration of a microcomputer, concerning transfer control of a parameter;

FIG. 10 is a flow chart illustrating execution operation of a user program using the software of the logical configuration explained in FIG. 9, in the data processing system illustrated in FIG. 8;

FIG. 11 is a block diagram illustrating an example that a serial flash memory is used as a nonvolatile memory device; and

FIG. 12 is a block diagram illustrating an example that the data processing system according to the present invention is applied to motor control.

### DETAILED DESCRIPTION

### 1. Outline of Embodiments

First, an outline of a typical embodiment of the invention disclosed in the present application is explained. A numerical symbol of the drawing referred to in parentheses in the outline explanation about the typical embodiment only illustrates what is included in the concept of the component to which the numerical symbol is attached.

(1) <Selecting a Program Exceeding the Capacity of a Built-In ROM and Loading to the Built-In ROM from the Exterior>

A data processing system (1, 1A) according to a typical embodiment of the present invention includes a semiconductor data processing device (10, 10A), a nonvolatile semiconductor memory device (20, 20C) coupled to the semiconductor data processing device, and an output circuit (30, 40) coupled to the semiconductor data processing device. The semiconductor data processing device has a central processing unit (11), a rewritable nonvolatile memory (12) which stores a program executed by the central processing unit, an input/output controller (15, 19) which controls operation of the nonvolatile semiconductor memory device under the control of the central processing unit, and an external interface circuit (16, 17) coupled to the output circuit. The nonvolatile semiconductor memory device has plural program areas (20-1-20-N) storing plural programs. The nonvolatile memory has an executive program area (12-1) for storing a part of the plural programs. The central processing unit determines information supplied to the external interface circuit from the output circuit, reads a program from a program area corresponding to the determination result with the use of the input/output controller, stores the program read into the executive program area, and performs software reset processing for executing the program from a starting address.

According to the present device, in response to the determination result of the information supplied from the exterior, the semiconductor data processing device downloads an internally required program from the nonvolatile semiconductor memory device, and rewrites the on-chip nonvolatile memory. Accordingly, even if it is a program of a scale larger than the storage capacity of an available on-chip nonvolatile memory, it is possible to read the program directly from the on-chip nonvolatile memory residing in the semiconductor data processing device and to execute it at high speed. When the program of the on-chip nonvolatile memory residing in the semiconductor data processing device is rewritten, the software reset processing is performed to execute the program from a starting address. Accordingly, compared with the case where a power-on reset is performed to start the program execution, it does not take time to resume the program execution, and smooth resumption of the data processing is possible when the program to execute is switched.

(2) <Instructing a Program by a Port Input>

In the data processing system of Paragraph 1, the external interface circuit is an input port (16), and the central processing unit determines a corresponding program area on the basis of number data inputted into the input port.

Accordingly, it is possible to easily instruct rewrite of a program from the exterior via the input port.

(3) <Instructing a Program by a Serial Input>

In the data processing system of Paragraph 1, the external interface circuit is a serial input circuit (17), and the central processing unit determines a corresponding program area on the basis of serial data inputted into the serial input circuit.

Accordingly, it is possible to easily instruct rewrite of a program from the exterior via the serial input circuit.

(4) <Including a Program for Transfer Control>

In the data processing system of Paragraph 1, the program includes a first program (120,110,111,112) for transfer control and a second program for others. The first program determines information supplied to the external interface circuit from the output circuit, and when the determination result does not correspond to the currently running program, the first program reads a program from a program area corresponding to the determination result with the use of the input/output controller, stores the program read into the executive program area, and controls the software reset processing for executing the program from a starting address. The first program is enabled to run at predetermined timing during the second program is running.

Accordingly, since the program has the first program for transfer control as well as the second program, it is possible to smoothly perform processing accompanying the rewrite of a program, while executing the second program.

(5) <Memory Controller>

In the data processing system of Paragraph 1, the nonvolatile semiconductor memory device is an embedded memory card (20), and the input/output controller is a memory card controller (15) which performs input/output control to the embedded memory card.

According to this, in the semiconductor data processing device provided with a memory card controller, it is possible to divert the embedded memory card for storing of a large program.

(6) <Serial Peripheral Controller>

In the data processing system of Paragraph 1, the nonvolatile semiconductor memory device is a nonvolatile serial memory (20), and the input/output controller is a serial peripheral interface circuit (19) which can perform input/output control to the nonvolatile serial memory.

According to this, in the semiconductor data processing device provided with a serial peripheral interface circuit, it is possible to divert the nonvolatile serial memory for storing of a large program.

(7) <Selecting a Parameter Exceeding Capacity of a Built-In ROM and Loading to the Built-In ROM from the Exterior>

A data processing system (1B) according to another embodiment of the present invention includes a semiconductor data processing device (10B), a nonvolatile semiconductor memory device (20B, 20C) coupled to the semiconductor data processing device, and an output circuit (30B) coupled to the semiconductor data processing device. The semiconductor data processing device has a central processing unit (11), a rewritable nonvolatile memory (18) which stores a parameter utilized in data processing by the central processing unit, an input/output controller (15, 19) which controls operation of the nonvolatile semiconductor memory device under the control of the central processing unit, and an external interface circuit (16) coupled to the output circuit. The nonvolatile semiconductor memory device has plural parameter group areas (20B-1-20B-N) storing plural parameter groups. The nonvolatile memory has a temporary area (18-1) for storing a part of the plural parameter groups. The central processing unit determines information supplied to the external interface circuit from the output circuit, reads a parameter group from a parameter group area corresponding to the determination result with the use of the input/output controller, and stores the parameter group read in the temporary area.

According to the present device, in response to the determination result of the information supplied from the exterior, the semiconductor data processing device downloads an internally required parameter from the nonvolatile semiconductor memory device, and rewrites the on-chip nonvolatile memory. Accordingly, even if it is a parameter of a scale larger than the storage capacity of an available on-chip nonvolatile memory, it is possible to read the parameter directly from the on-chip nonvolatile memory residing in the semiconductor data processing device and to utilize it immediately.

(8) <Instructing a Parameter Group by a Port Input>

In the data processing system of Paragraph 7, the external interface circuit is an input port (16), and the central processing unit determines a corresponding temporary area on the basis of the number data inputted into the input port.

Accordingly, it is possible to easily instruct rewrite of a parameter from the exterior via the input port.

(9) <Instructing a Parameter Group by a Serial Input>

In the data processing system of Paragraph 7, the external interface circuit is a serial input circuit (17), and the central processing unit determines a corresponding temporary area on the basis of the serial data inputted into the serial input circuit.

Accordingly, it is possible to easily instruct rewrite of a parameter from the exterior via the serial input circuit.

(10) <Program for Rewrite Control of a Parameter>

In the data processing system of Paragraph 7, the central processing unit (11) determines the information supplied to the external interface circuit from the output circuit, and when the determination result does not correspond to the parameter group currently in use, the central processing unit reads a parameter group from a parameter group area corresponding to the determination result concerned with the use of the input/output controller, and enables execution of processing for storing the parameter group read into the temporary area at a predetermined timing during the execution of an application program.

Accordingly, it is possible to smoothly perform processing accompanying the rewrite of a parameter, while executing the application program.

(11) <Memory Controller>

In the data processing system of Paragraph 7, the nonvolatile semiconductor memory device is an embedded memory card (20B), and the input/output controller is a memory card controller (15) which performs input/output control to the embedded memory card.

According to this, in the semiconductor data processing device provided with a memory card controller, it is possible to divert the embedded memory card for storing of a parameter of large size.

(12) <Serial Peripheral Controller>

In the data processing system of Paragraph 7, the nonvolatile semiconductor memory device is a nonvolatile serial memory (20C), and the input/output controller is a serial peripheral interface circuit (19) which can perform input/output control to the nonvolatile serial memory.

According to this, in the semiconductor data processing device provided with a serial peripheral interface circuit, it is possible to divert the nonvolatile serial memory for storing of a parameter of large size.

### 2. Details of Embodiments

Hereinafter, the embodiments of the present invention are explained in further detail.

### Embodiment 1

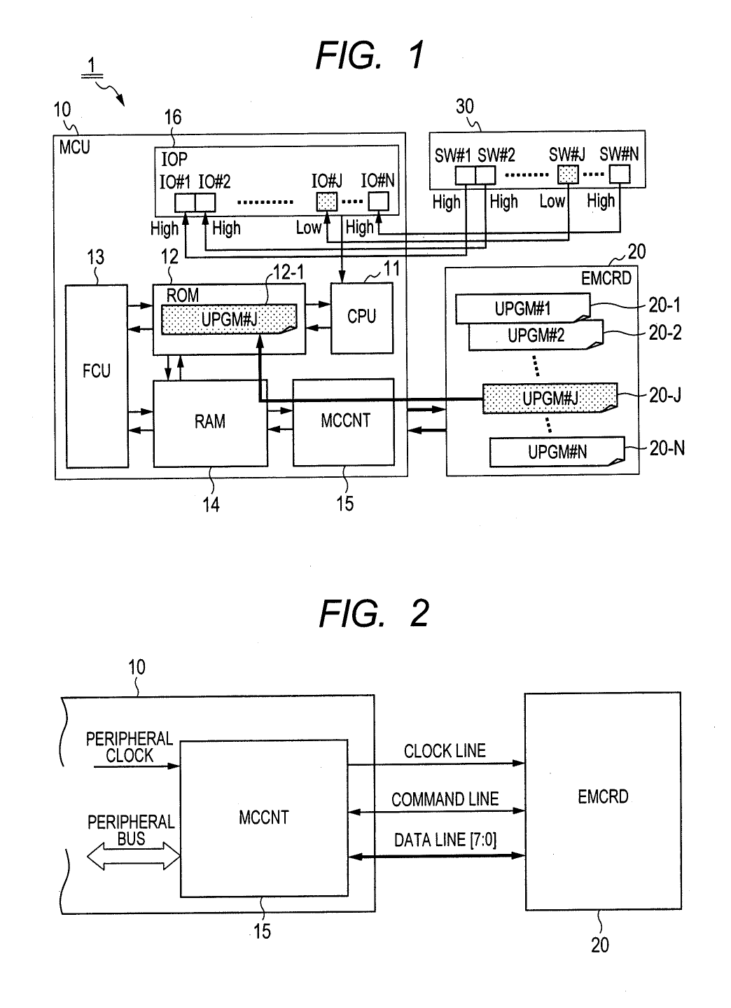

FIG. 1 illustrates a data processing system according to Embodiment 1 of the present invention. The data processing system 1 illustrated in FIG. 1 includes a microcomputer 10 as the semiconductor data processing device, an embedded memory card (EMCRD) 20 as the nonvolatile semiconductor memory device coupled to the microcomputer 10, and a program selecting switch circuit 30 as the output circuit coupled to the microcomputer 10, and others. Although not limited in particular, these components are implemented over a predetermined wiring substrate (not shown).

Although not limited in particular, the microcomputer 10 is formed over a semiconductor substrate such as single crystal silicon, with a CMOS integrated circuit manufacturing technology, etc. The microcomputer 10 includes a central processing unit (CPU) 11, an electrically rewritable nonvolatile memory (ROM) 12, an erase-write control circuit (FCU) 13 which performs sequence control of an erase and write operation to the nonvolatile memory 12, a RAM 14, a memory card controller (MCCNT) 15 which controls operation of the embedded memory card 20, an input/output port (IOP) 16, etc. The RAM 14 is employed as a work space of a program and an area for storing data temporarily.

FIG. 1 illustrates that each circuit module inputs and outputs signals to and from the adjacent circuit module, but this is only a schematic representation of the typical signal input-output mode. In practice, the circuit modules are coupled with each other via an internal bus. Although not shown, for example, the CPU 11, the ROM 12, and the RAM 14 are coupled via the high-speed internal bus which performs signal transfer at a bus cycle comparable to an operating cycle of the CPU 11. The internal bus is coupled to a peripheral bus via a bus bridge circuit or a bus controller. The peripheral bus operates at a lower speed than the internal bus, and the FCU 13, the MCCNT 15, the IOP 16, etc. are coupled to the peripheral bus, as a circuit module for which a high-speed clock operation is not always needed.

The nonvolatile memory 12 is configured with a memory cell array in which electrically rewritable stack gate-type or split gate-type memory cells, similar to nonvolatile memory elements of a flash memory, are arranged in a matrix. The nonvolatile memory 12 is used for storing a program which the CPU 11 executes. A part of the nonvolatile memory 12 is allotted to a storing area 12-1 of the user program UPGM#i. FIG. 1 illustrates a case of i=J.

The erase-write control circuit 13 to the nonvolatile memory 12 is the exclusive-use hardware which performs the sequence control of erase operation and write operation to the nonvolatile memory 12, in response to an erase command and a write command supplied from the CPU 11 via the peripheral bus. The nonvolatile memory 12 enables write to the ROM 12, even when the CPU 11 is executing other task. The CPU 11 can perform read from the nonvolatile memory 12 at high speed via the internal bus.

The MCCNT 15 is hardware which controls the EMCRD 20 in response to a memory card command supplied from the CPU 11.

N input/output circuits IO#1-IO#N are typically shown in the IOP 16. The input/output circuits IO#1-IO#N are supplied with switch signals corresponding to the switch state of N switches SW#1-SW#N of the program selecting switch circuit 30. Although not limited in particular, each switch signal is assumed to be 1 bit. The state of each I/O port to be controlled is reflected by the program selecting switch. The state of the input/output circuits IO#1-IO#N to which the switch state is reflected is monitored by the CPU 11.

Although not limited in particular, the embedded memory card 20 is a flash memory card for a built-in use, and is implemented over a circuit board by being fixed via an external terminal with the use of BGA (ball grid array). The embedded memory card 20 includes nonvolatile program areas 20-1-20-N for storing N user programs UPGM#1-UPGM#N (N is a positive integer) in a rewritable manner. This embedded memory card 20 is provided with a memory interface conforming to a multimedia card (MultiMediaCard/MMC: registered trademark), for example. The memory card controller 15 of the microcomputer 10 performs access control of the memory card using the memory card interface provided to the embedded memory card 20. Even when there is updating of storage capacity or specification, etc. of the embedded memory card 20, the control by the memory card controller 15 can be performed in the range of compatibility.

Here, the storage capacity of the ROM 12 is very small compared with the storage capacity of the embedded memory card 20; for example, it is about several hundred KB to 1 MB, which is the storage capacity large enough to store one user program, in addition to a system program such as OS, and necessary parameter data. This is for suppressing the cost rise of a microcomputer and the enlargement of a chip, which will be caused by providing an electrically rewritable on-chip nonvolatile memory with large storage capacity.

The switches SW#1-SW#N of the program selecting switch circuit 30 correspond to the program areas 20-1-20-N of the user programs UPGM#1-UPGM#N, respectively. A Low output by an on state indicates selection to a corresponding program area and a High output by an off state indicates non selection. The program selecting switch circuit 30 forbids that plural switches among the switches SW#1-SW#N become an on state concurrently.

The switch state of the switches SW#1-SW#N is reflected in the input/output circuits IO#1-IO#N of the input/output port 16. The CPU 11 monitors the state of the input/output circuits IO#1-IO#N, and performs processing for writing a user program of the number specified by the input/output circuits into the ROM 12. For example, when the CPU 11 newly detects that the number #J of the user program has been specified, the CPU 11 controls to transfer the user program UPGM#J from the storage area 20-J of the EMCRD 20 to the RAM 14 via MCCNT 15, then, the CPU 11 controls to write the user program UPGM#J in the ROM 12 via the FCU 13. Although not limited in particular, the present control is performed after the CPU 11 executes other user programs which are stored in the ROM 12 before writing the user program UPGM#J. When the write of the new user program UPGM#J is completed, although not limited in particular, but the CPU 11 performs a software reset and enables the execution of the user program UPGM#J concerned. As the software reset, initialization of register sets, such as a general-purpose register and a program counter of the CPU 11, is performed, and instruction fetch is started from the starting address of the user program UPGM#J, for example.

FIG. 2 illustrates interface signals between the MCCNT and the EMCRD. In FIG. 2, the MCCNT and the EMCRD are coupled with a clock line, a command line, and eight data lines. The MCCNT 15 generates a clock signal to be supplied to the clock line, by dividing a peripheral clock signal in the microcomputer 10, and the clock signal is supplied from the MCCNT 15 to the EMCRD 20 via the clock line. Via the command line, a command conforming the interface specification of the memory card concerned is outputted from the MCCNT 15 to the EMCRD 20 and a response to the command is transferred from the EMCRD 20 to the MCCNT 15. Via the data line, write-in data is supplied from the MCCNT 15 to the EMCRD 20 and read-out data is supplied from the EMCRD 20 to the MCCNT 15. The number of the data line to be employed is not restricted to eight, but it may be one or four.

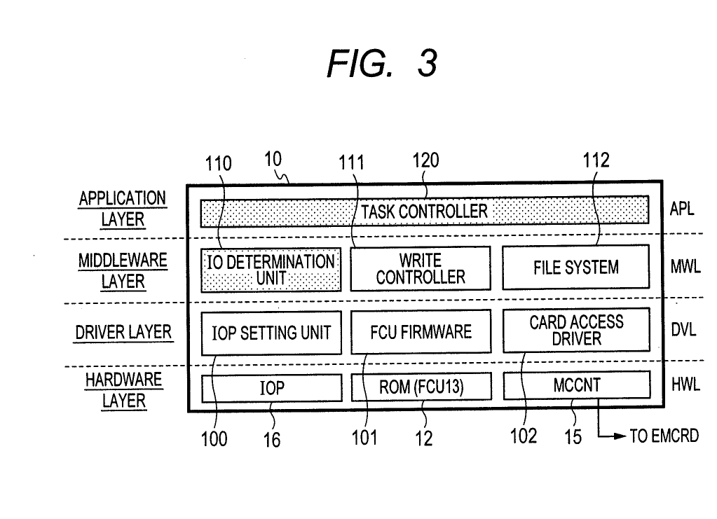

FIG. 3 illustrates a logical configuration of the microcomputer 10, concerning transfer control of the user program. Here, the logical configuration is divided roughly into a hardware layer (HWL), a driver layer (DVL), a middleware layer (MWL), and an application layer (APL).

As the hardware layer (HWL), the IOP 16, the ROM 12, the FCU 13, and the MCCNT 15 are illustrated.

The driver layer (DVL) is provided with, for example, a function setting unit 100 of the IOP 16 which sets up the correspondence between the input/output circuits IO#1-IO#N and the switches SW#1-SW#N, an FCU firmware 101 which specifies the erase and write control sequence of the ROM 12 by the FCU 13, and a card access driver 102 for the read access operation which controls the MCCNT 15 and reads the user program from the EMCRD 20.

The middleware layer (MWL) is provided with an IO determination unit 110, a write controller 111, and a file system 112. The IO determination unit 110 is a program for determining the input state of a Low or a High of each input/output circuit IO#1-IO#N, which reflects the state of the program selecting switch circuit 30. The write controller 111 is a program for performing the write control concerning the erase and write operation to the ROM, using a command corresponding to the function provided by the FCU firmware 101. The file system 112 is a program for managing the user programs UPGM#1-UPGM#N in the EMCRD 20 as a file, thereby allowing the program of the higher-order application layer to treat the data inside the EMCRD 20 as a file. Here, the explanation has been made about the example that the user programs UPGM#1-UPGM#N are stored as a file in the EMCRD 20. However, it is also preferable that the user programs UPGM#1-UPGM#N are stored as data in the EMCRD 20 and the special-purpose software for user program access is implemented instead of the file system.

The application layer (APL) is provided with a task controller 120. The task controller 120 is a program for controlling the overall task for the microcomputer, such as operation according to the state of the IOP 16 using the IO determination unit 110, write operation to the ROM. 12 using the write controller 111, read operation of a file from the EMCRD 20 using the file system 112, and others.

Although not limited in particular, each of the user programs UPGM#1-UPGM#N has a program of the application layer (APL) (a part of programs which configure the task controller 120) used for the transfer control of the user program. The programs of the middleware layer (MWL) and the driver layer (DVL) which are used for the transfer control of the user program may be executed by calling from each application program; accordingly, it is not necessary to provide them individually to each of the user programs UPGM#1-UPGM#N, and what is necessary is that they are just stored fixedly in a storage area other than the user program area of the ROM 12. It is also preferable that the program of the application layer (APL) (a part of programs which configure the task controller 120) used for the transfer control of the user program is provided in common to the user programs UPGM#1-UPGM#N, as is the case with the programs of the middleware layer (MWL) and the driver layer (DVL) which are used for the transfer control of the user program

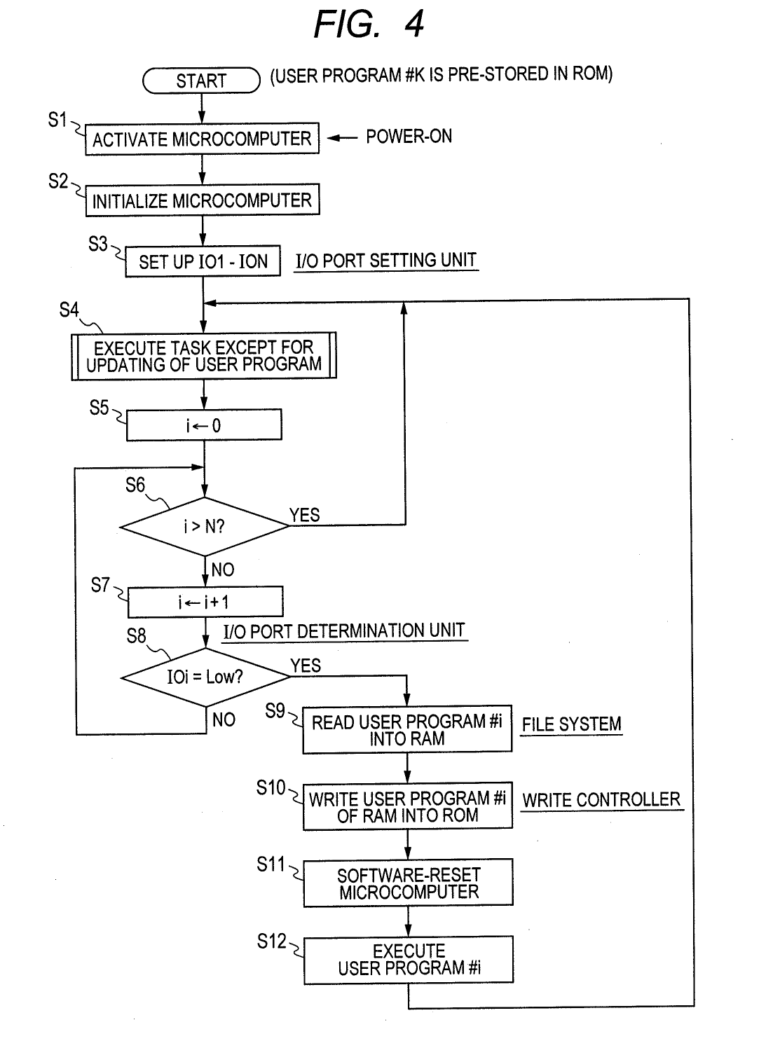

FIG. 4 is a flow chart illustrating execution operation of the user program using the software of the logical configuration explained in FIG. 3, in the data processing system illustrated in FIG. 1. Here, it is assumed that the user program UPGM#K is stored in the ROM 12 initially.

When a power supply is switched on to activate the microcomputer 10 (S1), initial setting to the operating frequency of the microcomputer 10 and initial setting to a peripheral module, etc. are performed by the power-on reset processing (S2). To the input/output port 16, correspondence with the program selecting switch circuit 30 is set by the IO function setting unit 100 (S3).

Subsequently, the user program UPGM#K stored in the ROM is executed from the starting address (S4). That is, execution of tasks except for updating of the user program is started. The tasks include motor control, decode of an image, and communications with other equipment, for example. In process of the tasks, processing for updating the user program is performed. That is, the CPU 11 initializes a reference number parameter i to 0 (S5), then the CPU 11 increments the parameter i by +1 (S7) until the value of the parameter i concerned reaches N (S6) and determines whether the input of an input/output circuit of the number specified by the parameter concerned, that is the input/output circuit IO#i, is in a Low state (S8). It is decided by the state of the program selecting switch circuit 30 which input/output circuit IO#i has an input which is set in a Low state. Although not illustrated in particular, the number of the currently running user program is grasped by the CPU 11, and it cannot be needless to say that the number of the currently running user program is removed from the determination target in the determination at Step S8.

When the input/output circuit of which the state is “Low” is identified, the CPU 11 determines that there is an update request of the user program #i indicated by the number, and reads the user program #i from the EMCRD 20 to the RAM 14 with the use of the file system 112 (S9). For example, it is assumed that i=J. The user program #i read in the RAM 14 is written in the ROM 12 by the write controller 111 (S10). After that, the microcomputer 10 undergoes software reset and the register set of the CPU 11 is initialized (S11). A power-on reset is not performed. Initialization of the register set accompanying the software reset is realized by hardware, for example. Accordingly, the CPU 11 starts the execution of the user program #i (S12), and executes the task specified by the program (S4).

According to Embodiment 1, it is possible to update the user program while the microcomputer is activated, without employing an external communication terminal or implementing a card socket. It is possible for the microcomputer to execute plural user programs which exceed the capacity of the ROM 12.

Responding to the determination result of the information supplied from the program switch circuit 30, the microcomputer 10 downloads a necessary program from the EMCRD 20, and rewrites the on-chip ROM 12. Accordingly, even if it is a program of a scale larger than the storage capacity of the available on-chip ROM, it is possible to read the program directly from the on-chip ROM residing in the microcomputer 10 and to execute it at high speed.

When the program of the on-chip ROM 12 residing in the microcomputer 10 is rewritten, the software reset processing is performed to execute the program from a starting address. Accordingly, compared with the case where the power-on reset is performed to start the program execution, it does not take time to resume the program execution, and smooth resumption of the data processing is possible when the program to execute is switched.

### Embodiment 2

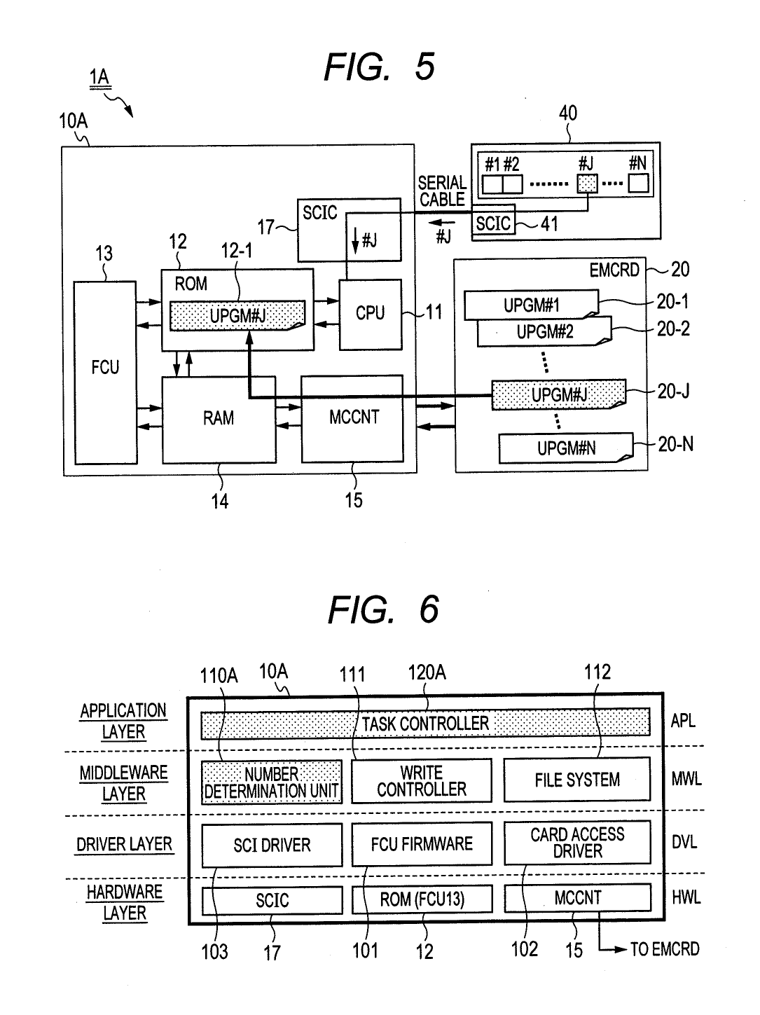

FIG. 5 illustrates a data processing system according to Embodiment 2 of the present invention. The data processing system 1A illustrated in FIG. 5 includes a microcomputer 10A as the semiconductor data processing device, an embedded memory card (EMCRD) 20 as the nonvolatile semiconductor memory device coupled to the microcomputer 10A, and a serial terminal unit 40 as the output circuit coupled to the microcomputer 10A, and others. Although not limited in particular, these components are implemented over a predetermined wiring substrate (not shown).

The microcomputer 10A includes a serial communication interface controller (SCIC) 17 which performs serial communication control under the control of the CPU 11. A serial terminal unit 40 is coupled to the SCIC 17, via a serial cable, for example. The coupling is not restricted to the serial cable but maybe interfaced by non-contact serial communication. The SCIC 17 is supplied with selection data #i generated by communication application of the serial terminal 40 via an SCIC 41. The selection data #i has one of values #1-#N. The CPU 11 monitors the input of the selection data #i from the SCIC 17. As is the case with Embodiment 1, the values #1-#N of the selection data #i correspond to the numbers of the user programs UPGM#1-UPGM#N, respectively. The CPU 11 controls transferring, from the EMCRD 20 to the RAM 14, the user program corresponding to the number #i inputted from the SCIC 17, and also controls writing it to the ROM 12. The other configuration of the microcomputer 10A is the same as illustrated in FIG. 1, and the same reference symbol is attached to a circuit which has the identical function, and the detailed explanation thereof is omitted. FIG. 5 illustrates the case of i=J, same as illustrated in FIG. 1.

FIG. 6 illustrates a logical configuration of the microcomputer 10A, concerning transfer control of the user program. Here, the logical configuration is divided roughly into a hardware layer (HWL), a driver layer (DVL), a middleware layer (MWL), and an application layer (APL).

FIG. 6 is different from FIG. 3 in the point that in FIG. 6, the hardware layer (HWL) has the SCIC 17, the driver layer (DVL) has an SCI driver, and a task controller 120A is an application program including the SCIC 17 as the control object. The SCI driver 103 controls the SCIC 17 and controls receiving of number data #i which the user has selected from the serial terminal 40. The number determination unit 110A is a program for determining the number #i received from the serial terminal 40. The other logical configurations are the same as that of FIG. 3; therefore, the same reference symbol is attached to the identical function, and the detailed explanation thereof is omitted.

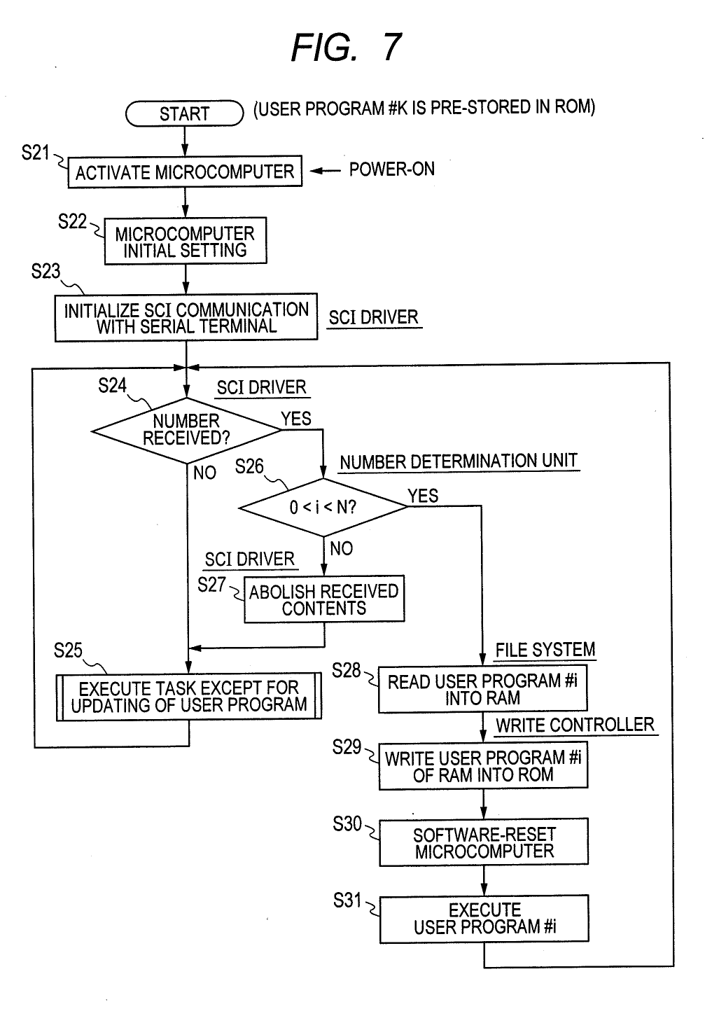

FIG. 7 is a flow chart illustrating execution operation of the user program using the software of the logical configuration explained in FIG. 6, in the data processing system illustrated in FIG. 5. Here, it is assumed that the user program UPGM#K is stored in the ROM 12 initially.

When a power supply is switched on to activate the microcomputer 10A (S21), initial setting to the operating frequency of the microcomputer 10A and initial setting to a peripheral module, etc. are performed by the power-on reset processing (S22). The communication condition with the serial terminal 40 and others are set in the SCIC 17 by the SCI driver 103 (S23). Accordingly, it is determined whether the number #i is received by the SCIC 17 (S24).

When there is no number reception, the user program UPGM#K stored in the ROM 12 starts to be executed from the starting address (S25). That is, execution of tasks except for updating of the user program is started. The tasks include motor control, decode of an image, and communications with other equipment, for example. In process of the tasks, the existence or nonexistence of the number reception is successively determined (S24).

When the number reception is determined, processing for updating the user program is performed. That is, the CPU 11 determines whether the received number satisfies the condition that 0<i<N (S26). When the received number does not satisfy the condition, the received number is abolished and the flow returns to Step S25. Although not illustrated in particular, the number of the currently running user program is grasped by the CPU 11, and it cannot be needless to say that the number of the currently running user program is removed from the determination target in the determination at Step S26.

When the received number satisfies the condition that 0<i<N, the CPU 11 determines that there is an update request of the user program #i indicated by the number, and reads the user program #i from the EMCRD 20 to the RAM 14 with the use of the file system 112 (S28). For example, it is assumed that i=J. The user program #i read in the RAM 14 is written in the ROM 12 by the write controller 111 (S29). After that, the microcomputer 10A undergoes software reset and the register set of the CPU 11 is initialized (S30). A power-on reset is not performed. Accordingly, the CPU 11 starts the execution of the user program #i (S31), and executes the task specified by the program (S25)

According to Embodiment 2, it is possible to update the user program while the microcomputer 10A is activated, without coupling the switching circuit to the microcomputer 10A via the IOP. In addition, Embodiment 2 provides the same operation-effect as Embodiment 1.

### Embodiment 3

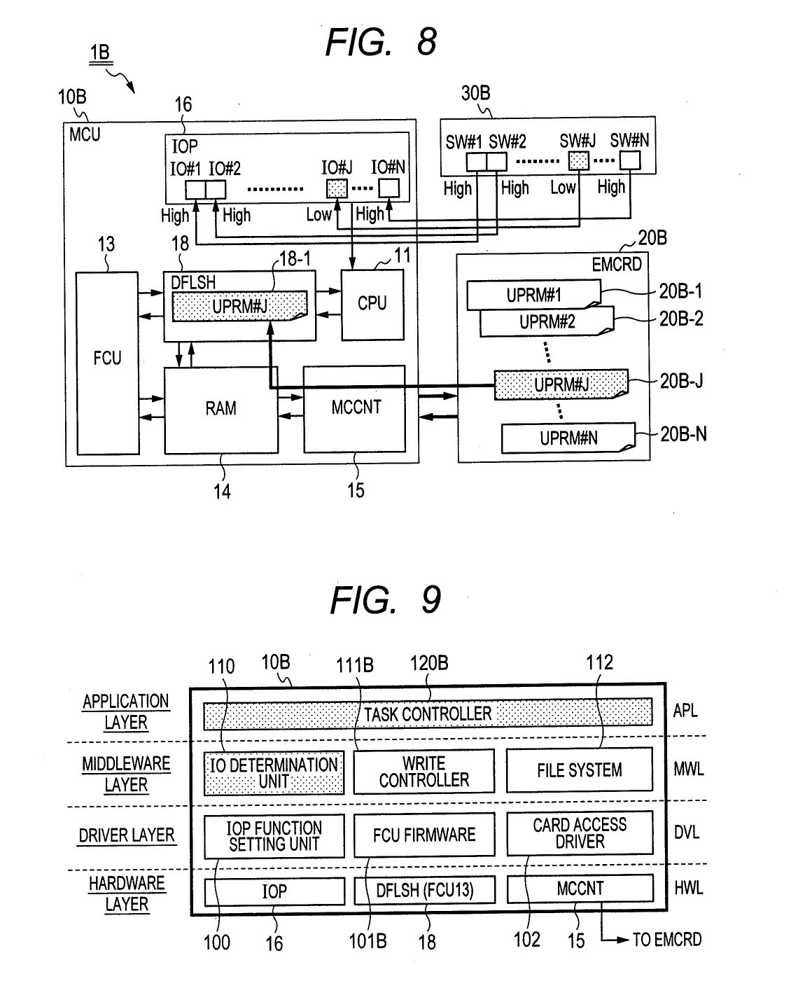

FIG. 8 illustrates a data processing system according to Embodiment 3 of the present invention. The data processing system 1B illustrated in FIG. 8 includes a microcomputer 10B as the semiconductor data processing device, an embedded memory card (EMCRD) 20B as the nonvolatile semiconductor memory device coupled to the microcomputer 10B, and a parameter selecting switch circuit 30B as the output circuit coupled to the microcomputer 10B. Although not limited in particular, these components are implemented over a predetermined wiring substrate (not shown).

As illustrated in FIG. 8, the microcomputer 10B includes a data flash memory (DFLSH) 18 as an electrically rewritable nonvolatile memory. The data flash memory 18 is utilized for storing data in a rewritable manner. A part of the data flash memory 18 is utilized as a temporary area 18-1 which stores a parameter used by the CPU 11 in the data processing, in a rewritable manner. The erase-write control circuit (FCU) 13 performs the sequence control of the erase and write operation to the data flash memory 18. As for the other circuits, the same reference symbol as in FIG. 1 is attached to a circuit which has the identical function, and the detailed explanation thereof is omitted. Although a ROM for storing a program is not shown in FIG. 8, the microcomputer 1B may include the ROM for storing a program, and the circuit explained in FIG. 1, for example, may be provided. In the microcomputer 10B, the same reference symbol is attached to the same circuit as in FIG. 1, and the detailed explanation thereof is omitted.

FIG. 8 illustrates that each circuit module inputs and outputs signals to and from the adjacent circuit module, but this is only a schematic representation of the typical signal input-output mode. In practice, the circuit modules are coupled with each other via an internal bus. Although not shown, for example, the CPU 11, the DFLSH 18, and the RAM 14 are coupled via a high-speed internal bus which performs signal transfer at a bus cycle compatible to an operating cycle of the CPU 11. The internal bus is coupled to a peripheral bus via a bus bridge circuit or a bus controller. The peripheral bus operates at a lower speed than the internal bus, and the FCU 13, the MCCNT 15, the IOP 16, etc. are coupled to the peripheral bus, as a circuit module for which a high-speed clock operation is not always needed.

Although not limited in particular, the embedded memory card 20B is a flash memory card for a built-in use, and is implemented over a circuit board by being fixed via an external terminal with the use of BGA (ball grid array). The embedded memory card 20B includes a nonvolatile parameter area 20B-1-20B-N for storing N parameter groups UPRM#1-UPRM#N (N is a positive integer) in a rewritable manner. This embedded memory card 20B is provided with a memory interface conforming to a multimedia card (MultiMediaCard/MMC: registered trademark), for example. The memory card controller 15 of the microcomputer 10B performs access control of the memory card using the memory card interface provided to the embedded memory card 20B. Even when there is updating of storage capacity or specification, etc. of the embedded memory card 20B, the control by the memory card controller 15 can be performed in the range of compatibility.

Here, the storage capacity of the DFLSH 18 is markedly small compared with the storage capacity of the embedded memory card 20B. This is for suppressing the cost rise of a microcomputer and the enlargement of a chip, which will be caused by providing an electrically rewritable on-chip nonvolatile memory with large storage capacity.

The switches SW#1-SW#N of the parameter selecting switch circuit 30B correspond to the parameter areas 20B-1-20B-N of the parameters UPRM#1-UPRM#N, respectively. A Low output by an on state indicates selection to a corresponding parameter area and a High output by an off state indicates non selection. The parameter selecting switch circuit 30B forbids that plural switches among the switches SW#1-SW#N become an on state concurrently.

The switch state of the switches SW#1-SW#N is reflected in the input/output circuits IO#1-IO#N of the input/output port 16. The CPU 11 monitors the state of the input/output circuits IO#1-IO#N, and performs processing for writing in the DFLSH 18 a parameter of the number specified by the input/output circuits. As illustrated in FIG. 8 for example, when the CPU 11 newly detects that the number #J of the parameter has been specified, the CPU 11 controls to transfer the parameter UPRM#J from the storage area 20B-J of the EMCRD 20B to the RAM 14 via the MCCNT 15, then, the CPU 11 controls to write the parameter UPRM#J in the DFLSH 18 via the FCU 13. Although not limited in particular, the control is performed by the CPU 11 executing the user program.

FIG. 9 illustrates a logical configuration of the microcomputer 10B, concerning transfer control of the parameter. Here, the logical configuration is divided roughly into a hardware layer (HWL), a driver layer (DVL), a middleware layer (MWL), and an application layer (APL).

In FIG. 9, as a hardware layer (HWL), the IOP 16, the DFLSH 18, the FCU 13, and the MCCNT 15 are illustrated.

The driver layer (DVL) is provided with, for example, a function setting unit 100 of the IOP 16 which sets up the correspondence between the input/output circuits IO#1-IO#N and the switches SW#1-SW#N, an FCU firmware 101B which specifies the erase and write control sequence of the DFLSH 18 by the FCU 13, and a card access driver 102 for the read access operation which controls the MCCNT 15 and reads the parameter from the EMCRD 20B.

The middleware layer (MWL) is provided with an IO determination unit 110, a write controller 111B, and a file system 112. The IO determination unit 110 is a program for determining the input state of a Low or a High of each input/output circuit IO#1-IO#N, which reflects the state of the parameter selecting switch circuit 30B. The write controller 111B is a program for performing the write control concerning an erase and write operation of the DFLSH 18 using a command corresponding to the function provided by the FCU firmware 101B. The file system 112 is a program for managing the parameters UPRM#1-UPRM#N in the EMCRD 20B as a file, thereby allowing the program of the higher-order application layer to treat the data inside the EDMCRD 20B as a file. Here, the explanation has been made about the example that the parameters UPRM#1-UPRM#N are stored as a file in the EMCRD 20B. However, it is also preferable that the parameters UPRM#1-UPRM#N are stored as data in the EMCRD 20B, and the special-purpose software for user program access is implemented instead of the file system.

The application layer (APL) is provided with a task controller 120B. The task controller 120B is a program for controlling the overall task for the microcomputer, such as operation according to the state of the IOP 16 using the IO determination unit 110, write operation to the DFLSH 18 using the write controller 111B, read operation of a file from the EMCRD 20B using the file system 112, and others.

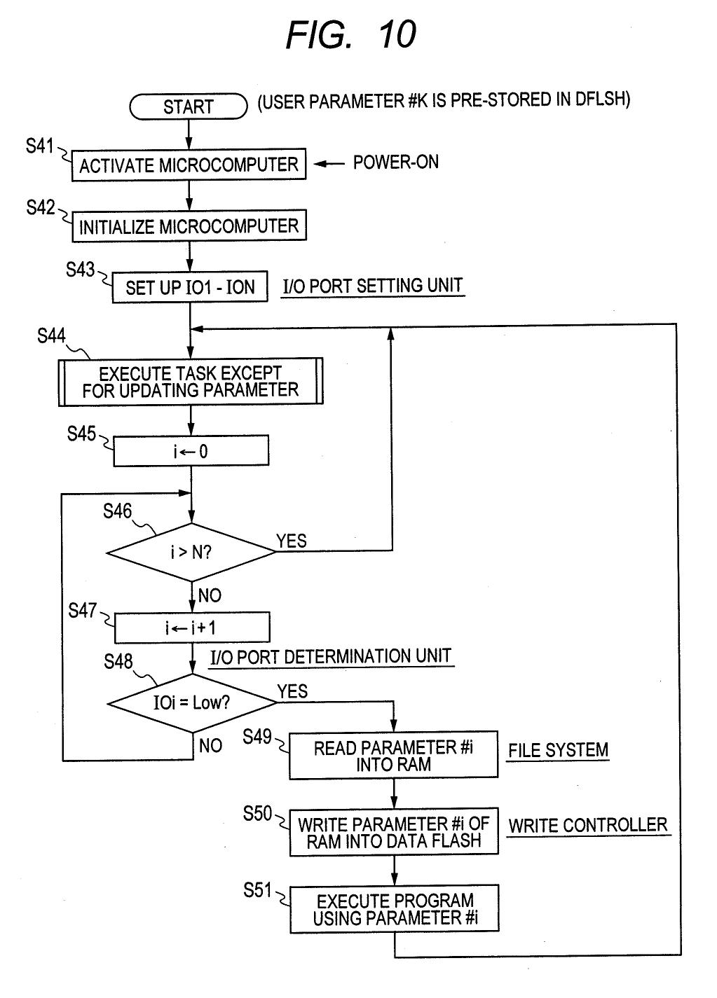

FIG. 10 is a flow chart illustrating execution operation of the user program using the software of the logical configuration explained in FIG. 9, in the data processing system illustrated in FIG. 8. Here, it is assumed that the parameter UPRM#K is stored in the DFLSH 18 initially.

When a power supply is switched on to activate the microcomputer 10B (S41), initial setting to the operating frequency of the microcomputer 10B and initial setting to a peripheral module, etc. are performed by the power-on reset processing (S42). To the input/output port 16, correspondence with the parameter selecting switch circuit 30B is set by the IO function setting unit 100.

Subsequently, the user program is executed from the starting address (S44). That is, execution of tasks except for updating of the parameter is started. The tasks include motor control, decode of an image, and communications with other equipment, for example. In process of the tasks, processing for updating the parameter is performed. That is, the CPU 11 initializes a reference number parameter i to 0 (S45), then the CPU 11 increments the parameter i by +1 (S47) until the value of the parameter i concerned reaches N (S46) and determines whether the input of an input/output circuit of the number specified by the parameter concerned, that is the input/output circuit IO#i, is in a Low state (S48). It is decided by the state of the parameter selecting switch circuit 30B which input/output circuit IO#i has an input set in a Low state. Although not illustrated in particular, the number of the parameter currently in use is grasped by the CPU 11, and it cannot be needless to say that the number of the parameter currently in use is removed from the determination target in the determination at Step S48.

When the input/output circuit of which the state is “Low” is identified, the CPU 11 determines that there is an update request of the parameter #i indicated by the number, and reads the parameter #i from the EMCRD 20B to the RAM 14 with the use of the file system 112 (S49). For example, it is assumed that i=J. The parameter UPRM#J read in the RAM 14 is written in the DFLSH 18 by the write controller 111 (S50). After that, the microcomputer 10B starts executing the program using the user parameter UPRM#i (S51), and executes a task (S44).

According to Embodiment 3, it is possible to obtain the following operation-effects.

It is possible to update the parameter UPRM#i while the microcomputer 10B is activated, without employing an external communication terminal or a card socket.

It is also possible for the microcomputer 10B to employ plural parameters UPRM#1-UPRM#N which exceed the storage capacity of the DFLSH 18.

Responding to the determination result of the #i-information supplied from the exterior, the microcomputer 10B downloads an internally required parameter from the EMCRD 20B, and rewrites the on-chip DFLSH 18. Accordingly, even if it is a parameter of a scale larger than the storage capacity of an available on-chip DFLSH 18, it is possible to read directly from the on-chip DFLSH 18 residing in the microcomputer 10B and to utilize it immediately.

### Embodiment 4

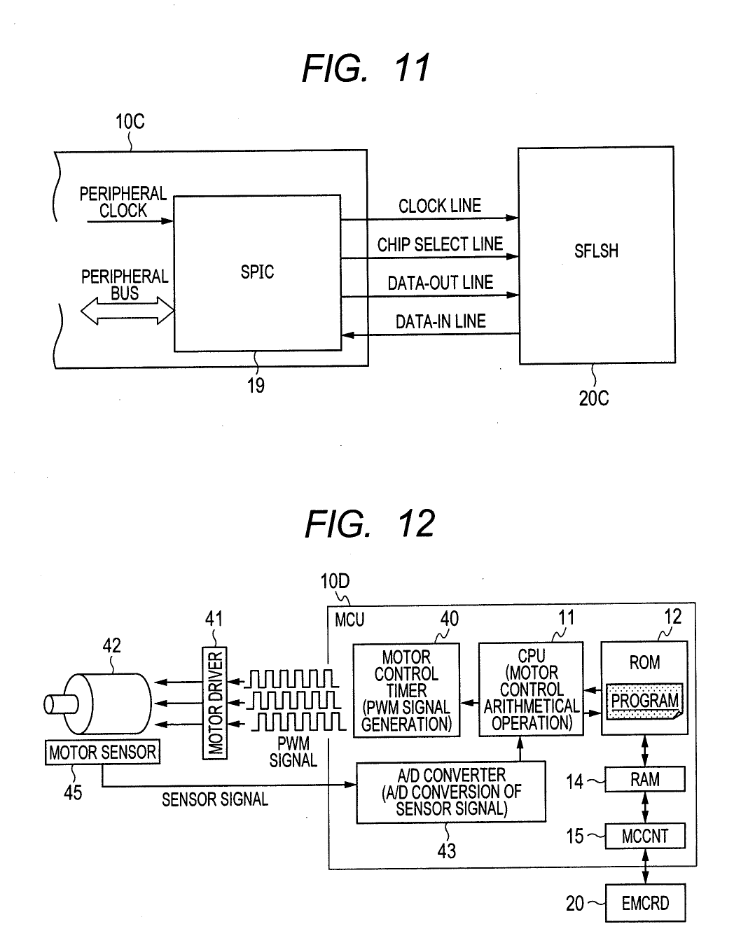

FIG. 11 illustrates an example that a serial flash memory is used as a nonvolatile memory device. A serial flash memory (SFLSH) 20C is slower than the EMCRD 20 in the access speed, however, the communications system for access is simple and creation of the software is easy, when compared with the EMCRD 20. The serial flash memory 20C has an advantage that the control can be performed by a serial interface and the required number of a terminal is small.

When the serial flash memory 20C is employed, the microcomputer 10C includes, as a peripheral circuit, a serial interface circuit (SPIC) 19 coupled to the serial flash memory 20C. The present serial interface is provided with the interface control function which is in conformity with what is called an SPI (Serial Peripheral Interface). The serial flash memory 20C is coupled with the SPIC 19 via a clock line, a chip select line, an input data (data-in) line, and an output data (data-out) line. The SPIC 19 divides the peripheral clock of the microcomputer 10C to generate a clock, and the generated clock signal is supplied from the SPIC 19 to the SFLSH 20C via the clock line. The SPIC19 transmits a chip selection signal to the SFLSH 20C via the chip select line. When the chip selection signal is set to a selection level, the SFLSH 20C is brought into a chip selected state, and the write and read of data are enabled. The data-out line transfers write-in data from the SPIC 19 to the SFLSH 20C, and the data-in line transfers read-out data from the SFLSH 20C to the SPIC 19. It is also possible to couple plural serial flash memories to the microcomputer. In that case, the microcomputer should just select each serial flash memory by the chip select line.

### Embodiment 5

FIG. 12 illustrates an example that the data processing system according to the present invention is applied to motor control. A motor for an industrial application is employed in the field of the positioning control of equipment, the control which requires time synchronization, etc. Accordingly, these motors require highly accurate control, and it is common to control the motor by a microcomputer.

The CPU 11 of the microcomputer 10D performs an arithmetical operation of the motor control according to the program stored in the ROM 12. A motor control timer 40 generates a PWM (Pulse Width Modulation) signal, based on the arithmetic result. The PWM signal in the shape of a square wave adjusts the interval of a High level and the interval of a Low level, thereby performs drive control of a motor 42 via a motor driver 41. An A/D converter 43 of the microcomputer 10D converts a sensor signal from the motor sensor 45 into a logical signal, thereby obtaining the operation information of the motor. The motor control arithmetical operation of the CPU 11 reflects the operation information of the motor 42.

When the contents of the motor control arithmetical operation are updated by rewriting the program of the ROM 12, it is necessary to rewrite the program while the microcomputer 10D is activated, in order to control the motor 42 normally. Therefore, by adopting the configuration for selective rewrite of the user program to the ROM 12, as explained in Embodiment 1 and others, it becomes possible to rewrite the user program efficiently, without performing the power-on reset of the microcomputer 10D, and to easily realize a high-speed motor control using the small-capacity on-chip ROM 12.

As described above, the invention accomplished by the present inventors has been concretely explained based on the embodiments. However, it cannot be overemphasized that the present invention is not restricted to the embodiments, and it can be changed variously in the range which does not deviate from the gist.

For example, the nonvolatile memory device is not restricted to the memory card or the serial flash memory, but can be changed to other nonvolatile memories. The output circuit is not restricted to the switching circuit or the serial terminal unit, but can be suitably changed to a register, etc. The on-chip nonvolatile memory is not restricted to the flash memory, but may be an MRAM, and others. The logical configuration of the microcomputer is not restricted to the hierarchy structure, as illustrated in FIG. 3 and others, but it may be another logical hierarchy structure in which no middleware layer exists. The present invention can be applied appropriately to other control fields besides the motor control. The present invention is not restricted to the case where each of the embodiments is realized independently and separately, however, it is also possible to realize appropriate combinations of each of the embodiments, depending on design requirements and other factors.

What is claimed is:

1. A data processing system comprising:
a semiconductor data processing device;
a nonvolatile semiconductor memory device coupled to the semiconductor data processing device; and
an output circuit coupled to the semiconductor data processing device,
wherein the semiconductor data processing device comprises:
a central processing unit;
a rewritable nonvolatile memory operable to store a program executed by the central processing unit;
an input/output controller operable to control operation of the nonvolatile semiconductor memory device under the control of the central processing unit; and
an external interface circuit coupled to the output circuit,
wherein the nonvolatile semiconductor memory device has a plurality of program areas storing a plurality of programs,
wherein the nonvolatile memory has an executive program area for storing a part of the plural programs, and
wherein the central processing unit determines information supplied to the external interface circuit from the output circuit, reads a program from a program area corresponding to the determination result with the use of the input/output controller, stores the program read into the executive program area, and performs software reset processing for executing the program from a starting address.

2. The data processing system according to claim 1,
wherein the external interface circuit is an input port, and
wherein the central processing unit determines a corresponding program area on the basis of number data inputted into the input port.

3. The data processing system according to claim 1,
wherein the external interface circuit is a serial input circuit, and
wherein the central processing unit determines a corresponding program area on the basis of serial data inputted into the serial input circuit.

4. The data processing system according to claim 1,
wherein the program includes a first program for transfer control and a second program for others,
wherein the first program determines information supplied to the external interface circuit from the output circuit, and when the determination result does not correspond to the currently running program, the first program reads a program from a program area corresponding to the determination result with the use of the input/output controller, stores the program read into the executive program area, and controls the software reset processing for executing the program from a starting address, and
wherein the first program is enabled to run at predetermined timing during the second program is running.

5. The data processing system according to claim 1,
wherein the nonvolatile semiconductor memory device is an embedded memory card, and
wherein the input/output controller is a memory card controller operable to perform input/output control to the embedded memory card.

6. The data processing system according to claim 1,
wherein the nonvolatile semiconductor memory device is a nonvolatile serial memory, and
wherein the input/output controller is a serial peripheral interface circuit operable to perform input/output control to the nonvolatile serial memory.

7. A data processing system comprising:
a semiconductor data processing device;
a nonvolatile semiconductor memory device coupled to the semiconductor data processing device; and
an output circuit coupled to the semiconductor data processing device,
wherein the semiconductor data processing device comprises:
a central processing unit;
a rewritable nonvolatile memory operable to store a parameter utilized in data processing by the central processing unit;
an input/output controller operable to control operation of the nonvolatile semiconductor memory device under the control of the central processing unit; and
an external interface circuit coupled to the output circuit,
wherein the nonvolatile semiconductor memory device has a plurality of parameter group areas storing a plurality of parameter groups,
wherein the nonvolatile memory has a temporary area for storing a part of the plural parameter groups,
wherein the central processing unit determines information supplied to the external interface circuit from the output circuit, reads a parameter group from a parameter group area corresponding to the determination result with the use of the input/output controller, and stores the parameter group read in the temporary area.

8. The data processing system according to claim 7,
wherein the external interface circuit is an input port, and
wherein the central processing unit determines a corresponding temporary area on the basis of number data inputted into the input port.

9. The data processing system according to claim 7,
wherein the external interface circuit is a serial input circuit, and
wherein the central processing unit determines a corresponding temporary area on the basis of serial data inputted into the serial input circuit.

10. The data processing system according to claim 7,
wherein the central processing unit determines information supplied to the external interface circuit from the output circuit, and when the determination result does not correspond to the parameter group currently in use, the central processing unit reads a parameter group from a parameter group area corresponding to the determination result concerned with the use of the input/output controller, and enables execution of processing for storing the parameter group read into the temporary area at a predetermined timing during the execution of an application program.

11. The data processing system according to claim 7,
wherein the nonvolatile semiconductor memory device is an embedded memory card, and
wherein the input/output controller is a memory card controller operable to perform input/output control to the embedded memory card.

12. The data processing system according to claim 7,
wherein the nonvolatile semiconductor memory device is a nonvolatile serial memory, and
wherein the input/output controller is a serial peripheral interface circuit operable to perform input/output control to the nonvolatile serial memory.
